(19) United States
(12) Patent Application Publication
(10) Pub. No.: US 2007/0297675 A1
(43) Pub. Date: Dec. 27, 2007

(54) Method of directed feature development for image pattern recognition

(75) Inventors: Shih-Jong J. Lee, Bellevue, WA (US); Seho Oh, Bellevue, WA (US)

Correspondence Address: SHIH-JONG J. LEE, 15418 SE 53RD PLACE, BELLEVUE, WA, 98006, US

(73) Assignee: Shih-Jong J. Lee

(21) Appl. No.: 11/475,644

(22) Filed: Jun. 26, 2006

(51) Int. Cl. G06K 9/62; G06K 9/46; G06K 9/66

(52) U.S. Cl. 382/190; 382/155

(57) ABSTRACT

A computerized directed feature development method receives an initial feature list, a learning image and object masks. Interactive feature enhancement is performed by human to generate feature recipe. The Interactive feature enhancement includes a visual profiling selection method and a contrast boosting method.

A visual profiling selection method for computerized directed feature development receives initial feature list, initial features, learning image and object masks. Information measurement is performed to generate information scores. Ranking of the initial feature list is performed to generate a ranked feature list. Human selection is performed through a user interface to generate a profiling feature. A contrast boosting feature optimization method performs extreme example specification by human to generate updated montage. Extreme directed feature ranking is performed to generate extreme ranked features. Contrast boosting feature generation is performed to generate new features and new feature generation rules.

### TECHNICAL FIELD

This invention relates to the enhancement of features in digital images to classify image objects based on the pattern characteristics features of the objects.

### BACKGROUND OF THE INVENTION

Significant advancement in imaging sensors, microscopes, digital cameras, and digital imaging devices coupled with high speed microprocessors, network connection and large storage devices enables broad new applications in image processing, measurement, analyses, and image pattern recognition.

Pattern recognition is a decision making process that classifies a sample to a class based on the pattern characteristics measurements (features) of the sample. The success of pattern recognition highly depends on the quality of the features. Patterns appearance on images depending on source object properties, imaging conditions and application setup. They could vary significantly among applications. Therefore, recognizing and extracting patterns of interest from images have been a longstanding challenge for a vast majority of the imaging applications.

Quality of features could impact the pattern recognition decision. Combination of feature selection and feature generation, almost unlimited supply of features can be provided. However, correlated features can skew decision model. Irrelevant features (not correlated to class variable) could cause unnecessary blowup of model space (search space). Irrelevant features can also drown the information provided by informative features in noisy condition (e.g. distance function dominated by random values of many uninformative features). Also, irrelevant features in a model reduce its explanatory value even when decision accuracy is not reduced. It is, therefore, important to define relevance of features, and filter out irrelevant features before learning the models for pattern recognition.

Because the specific features are so application specific, there is no general theory for designing an effective feature set. There are a number of prior art approaches to feature subset selection. A filter approach attempts to assess the merits of features from the data, ignoring the learning algorithm. It selects features using a preprocessing step. In contrast, a wrapper approach includes the learning algorithm as a part of its evaluation function.

One of the filter approach called FOCUS algorithm (Almuallim H. and Dietterich T. G., Learning boolean concepts in the presence of many irrelevant features. Artificial Intelligence, 69(1-2):279-306, 1994.), exhaustively examines all subsets of features to select the minimal subset of features. It has severe implications when applied blindly without regard for the resulting induced concept. For example, in a medical diagnosis task, a set of features describing a patient might include the patient's social security number (SSN). When FOCUS searches for the minimum set of features, it could pick the SSN as the only feature needed to uniquely determine the label. Given only the SSN, any learning algorithm is expected to generalize poorly.

Another filter approach called Relief algorithm (I. Kononenko. Estimating attributes: Analysis and extensions of RELIEF. In L. De Raedt and F. Bergadano, editors, Proc. European Conf. on Machine Learning, pages 171-182, Catania, Italy, 1994. Springer-Verlag), assigns a “relevance” weight to each feature. The Relief algorithm attempts to find all weakly relevant features but does not help with redundant features. In real applications, many features have high correlations with the decision outcome, and thus many are (weakly) relevant, and will not be removed by Relief.

The main disadvantage of the filter approach is that it totally ignores the effects of the selected feature subset on the performance of the learning algorithm. It is desirable to select an optimal feature subset with respect to a particular learning algorithm, taking into account its heuristics, biases, and tradeoffs.

A wrapper approach (R. Kohavi and G. John. Wrappers for feature subset selection. Artificial Intelligence, 97(1-2), 1997) conducts a feature space search for evaluating features. The wrapper approach includes the learning algorithm as a part of their evaluation function. The wrapper schemes perform some form of state space search and select or remove the features that maximize an objective function. The subset of features selected is then evaluated using the target learner. The process is repeated until no improvement is made or addition/deletion of new features reduces the accuracy of the target learner. Wrappers might provide better learning accuracy but are computationally more expensive than the Filter methods.

It is shown that neither filter nor wrapper approaches is inherently better (Tsamardinos, I. and C. F. Aliferis. Towards Principled Feature Selection: Relevancy, Filters, and Wrappers. in Ninth International Workshop on Artificial Intelligence and Statistics. 2003. Key West, Fla., USA.).

In addition, prior art method performs feature generation that building new features from a combination of existing features. For high-dimensional continuous feature data, feature selection and feature generation corresponds to data transformations. The data transformation projects data onto selected coordinates or low-dimensional subspaces (such as Principal Component Analysis) or Distance preserving dimensionality reduction such as Multidimensional scaling.

All prior arts use the data distribution for feature selection or feature generation automatically. When class labels are available, the statistical criteria related to class separation are used for feature selection or generation. When class labels are not available, information content such as coefficient of variations are used for feature selection and principal component analysis are used for feature generation.

The prior art methods make assumptions about data distribution which often do not match the observed data and the data are often corrupted by noise or imperfect measurements that could significantly degrade the feature development (feature selection and generation) results. On the other hand, the human application experts tend to have good understanding of application specific patterns of interest and they could easily tell the difference between true patterns and ambiguous patterns. A typical image pattern recognition application with expert input often does not need many features. Fewer features could lead to better results and will be more efficient for practical applications.

In a previous findings, it is reported that feature selection based on the labeled training set has little effect. Human feedback on feature relevance can identify a sufficient proportion (65%) of the most relevant features. It is also noted that humans have good intuition for important features and the prior knowledge could accelerate learning (Hema Raghavan, Omid Madani, Rosie Jones “InterActive Feature Selection” Proceedings of the 19th International Joint Conference on Artificial Intelligence, 2005).

It is desirable to have a feature development method that could utilize human application expertise. For easy human feedback, it is desirable that human could provide feedback without the need to know the mathematical formula underlying the feature calculations.

### Objects and Advantages

This invention provides a solution for interactive feature enhancement by human using the application knowledge. The application knowledge could be utilized directly by human without knowing the detailed calculation of the features. This could provide the critical solution to enable productive image pattern recognition feature development on a broad range of applications. The invention includes a visual profiling method for salient feature selection and a contrast boosting method for new feature generation and extreme directed feature optimization.

The visual profiling selection method ranks initial features by their information content. The ranked features can be profiled by object montage and object linked histogram. This allows visual evaluation and selection of a subset of salient features. The visual evaluation method spares human from the need to know the detailed feature calculation formula.

Another aspect of the invention allows human to re-arrange objects on montage display to specify extreme examples. This enables deeper utilization of application knowledge to guide feature generation and selection. Initial features can be ranked by contrast between the user specified extreme examples for application specific measurement selection. New features can also be generated automatically to boost the contrast between the user specified extreme examples for application specific feature optimization

In a particularly preferred, yet not limiting embodiment, the present invention automatically generates new features by combining two initial features to boost the contrast between the extreme examples. Using only two features and fixed combination types, the resulting new features are easily understandable by users.

The primary objective of the invention is to provide an interactive feature selection method by human, using the application knowledge, who does not have to know the detailed calculation of the features. The second objective of the invention is to allow the easy user interface that allows re-arrange objects on montage using mouse of simple keypads to specify extreme examples. The third objective of the invention is to provide extreme directed feature optimization. The fourth objective of the invention is to automatically generate new features by combining original features to boost the contrast between the extreme examples. The fifth objective of the invention is to generate new features that can be easily understood by users. The sixth objective of the invention is to avoid the degradation of noise or imperfect measurements to the feature development.

### SUMMARY OF THE INVENTION

A computerized directed feature development method receives an initial feature list, a learning image and object masks. Interactive feature enhancement is performed by human to generate feature recipe. The Interactive feature enhancement includes a visual profiling selection method and a contrast boosting method.

A visual profiling selection method for computerized directed feature development receives initial feature list, initial features, learning image and object masks. Information measurement is performed to generate information scores. Ranking of the initial feature list is performed to generate a ranked feature list. Human selection is performed through a user interface to generate a profiling feature. A contrast boosting feature optimization method performs extreme example specification by human to generate updated montage. Extreme directed feature ranking is performed to generate extreme ranked features. Contrast boosting feature generation is performed to generate new features and new feature generation rules.

### BRIEF DESCRIPTION OF THE DRAWINGS

The preferred embodiment and other aspects of the invention will become apparent from the following detailed description of the invention when read in conjunction with the accompanying drawings, which are provided for the purpose of describing embodiments of the invention and not for limiting same, in which:

FIG. 1 shows the processing flow for the application scenario of the interactive feature enhancement method;

FIG. 2 shows the sequential processing flow for the interactive feature enhancement method;

FIG. 3 shows the processing flow for the visual profiling selection method;

FIG. 4 shows the processing flow for the object montage creation method;

FIG. 5A shows an example image of cell nuclei;

FIG. 5B shows the object masks for the image in FIG. 5A;

FIG. 5C shows the object montage of a subset of the objects shown in FIG. 5B;

FIG. 6 shows the processing flow chart for the histogram creation method;

FIG. 7A shows the histogram plot of a feature for the objects shown in FIG. 5B;

FIG. 7B shows a bin of the histogram plot of FIG. 7A is selected and highlighted;

FIG. 8 shows the processing flow for the user interface method;

FIG. 9 shows the processing flow for the contrast boosting feature optimization method;

FIG. 10A shows an example object montage display;

FIG. 10B shows an updated montage of FIG. 10A where the extreme objects are highlighted by framing;

FIG. 11 shows the processing flow for the contrast boosting feature generation method.

### DETAILED DESCRIPTION OF THE INVENTION

### I. Application Scenario

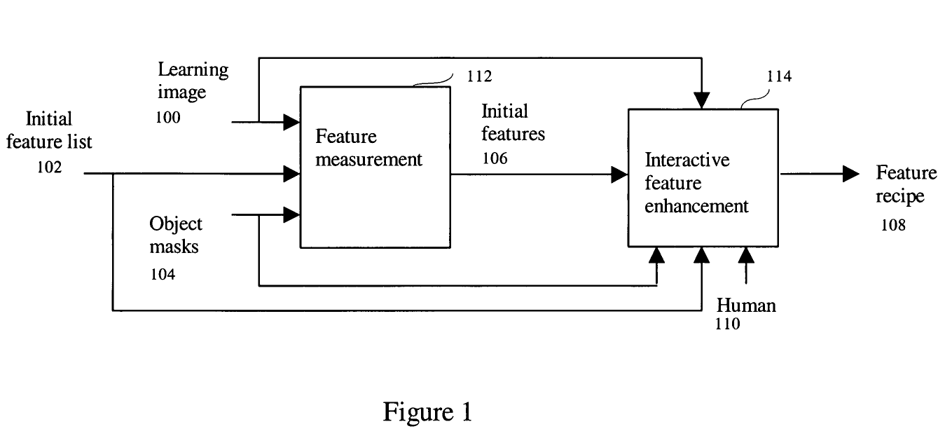

The application scenario of the directed feature development method is shown in FIG. 1. As shown in the figure, learning image 100, object masks 104, and initial feature list 102 are processed by a feature measurement step 112 implemented in a computer. The feature measurement step 112 generates initial features from the input feature list 102 using the learning image 100 and the object masks 104. The object masks are results from image segmentation such as image thresholding or other methods.

In one embodiment of the invention, the initial features 106 include
Morphology features such as area, perimeter, major and minor axis lengths, compactness, shape score, etc.
Intensity features such as mean, standard deviation, intensity percentile values, etc.
Texture features such as co-occurrence matrix derived features, edge density, run-length derived features, etc.
Contrast features such as object and background intensity ratio, object and background texture ratio, etc.

The initial features 106 along with the initial feature list 102, the learning image 100 and the object masks 104 are processed by the interactive feature enhancement step 114 of the invention to generate feature recipe 108. In one embodiment of the invention, the feature recipe contains a subset of the salient features that are selected as most relevant and useful for the applications. In another embodiment of the invention, the feature recipe includes the rules for new feature generation.

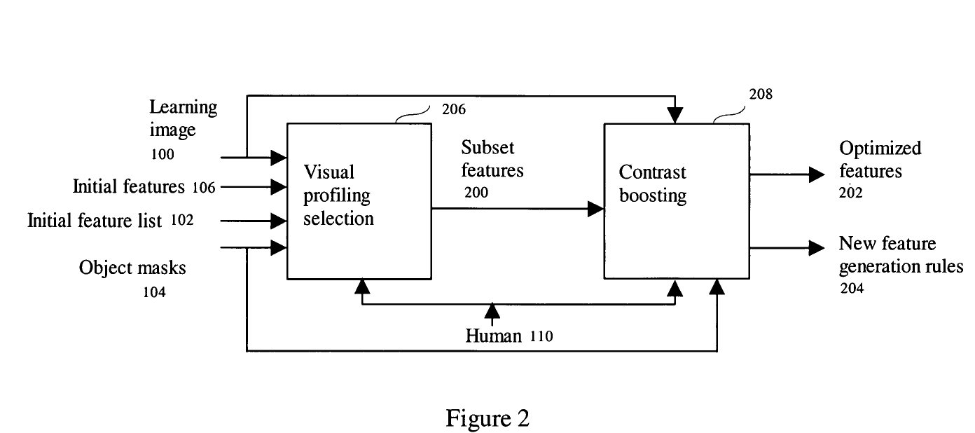

The interactive feature enhancement method further consists of a visual profiling selection step for interactive salient feature selection and a contrast boosting step for new feature generation. The two steps could be performed independently or sequentially. The sequential processing flow is shown in FIG. 2.

As shown in FIG. 2, the visual profiling selection step 206 processes the learning image 100, initial features 106, initial feature list 102 and object masks 104 and selects subset of initial features as subset features 200 by human 110. The subset features 200 along with the learning image 100 and object masks 104 are processed by the contrast boosting step 208 to generate optimized features 202. The optimized features 202 contain further selection of subset features and newly generated features. New feature generation rules 204 are also outputted from this step.

### II. Visual Profiling Selection

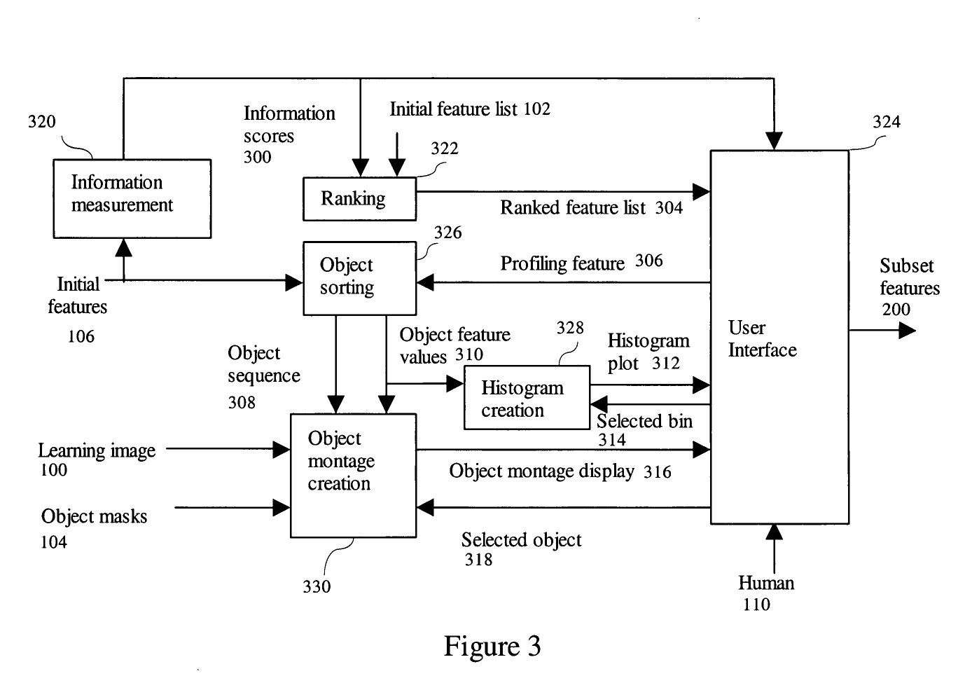

The visual profiling selection method allows the input from human application knowledge through visual examination without the need for human's understanding of the mathematical formula underlying the feature calculation. The processing flow for the visual profiling selection method is shown in FIG. 3. The initial features 106 are processed by a information measurement step 320 to generate information scores 300, at least one for each feature. The information scores 300 measure the information content for the initial features 106 on the initial feature list 102. The initial feature list 102 and the corresponding information scores 300 are processed by a ranking step 322 to generate a ranked feature list 304. The ranked feature list 304 is presented to human 110 through the user interface 324. The human 110 provides profiling feature 306 selection. The selected profiling feature 306 is processed by an object sorting step 326 that sorts the initial features 106 associated with the profiling feature 306. The object sorting step 326 sorts the initial profiling feature values and generate an object sequence 308 and their associated object feature values 310. The object sequence 308 and its associated object feature values 310, the learning image 100 and the object masks 104 are processed by the object montage creation step 330 to generate object montage display 316 according to the object sequence 308. The object montage display 316 is presented to the user interface 324 for human 110 visual examination and the selection of subset features 200. An optional histogram creation step 328 is also provided. The histogram creation step 328 inputs the object feature values 310 and generates a histogram plot 312 for displaying to human 110 through the user interface 200. The human 110 could select bin 314 from the user interface 324 that will be highlighted on the histogram plot 312 by the histogram creation step 328. Also, objects can be selected either from the histogram plot 312 or from the object montage display 316. The selected objects 318 are highlighted in the object montage display 316 by the object montage creation step 330.

### II.1 Information Measurement

The initial features contain the feature distributions for the learning objects. The information measurement method of this invention measures the information content of the feature distribution to generate at least one information score. In one embodiment of the invention, the information content such as coefficient of variation (standard deviation divided by mean) is used for the information score. In another embodiment of the invention, signal percentage is used as the information score measurement. The signal objects are objects whose feature values are greater than mean * (1+α) or are leas than mean * (1−α). Where α is a pre-defined factor such as 0.2.

When the objects are labeled as two classes, the one-dimensional class separation measures can be used for the information score. We can define between-class variance σ²_{b}, within-class variance σ²_{w}, and mixture class variance σ²ₘ. Common class separation measures include S₁/S₂, ln|S₁|−ln|S₂|, sqrt(S₁)/ Sqrt(S₂), etc. Where S₁ and S₁ are one of between-class variance σ²_{b}, within-class variance σ²_{w}, and mixture variance σ²ₘ (Keinosuke Fukunaga “Statistical Pattern Recognition”, 2^{nd} Edition, Morgan Kaufmann, 1990 P. 446-447).

In another embodiment of the invention, the unlabeled data can be divided into two classes by a threshold. The threshold could be determined by maximizing the value:

(N_{L}×m_{L}²)+(N_{H}×m_{H}²)

where N_{L} and N_{H} are the object counts of the low and high sides of the threshold, and m_{L}², m_{H}² are the second order moments on the left and right sides of the threshold. After the two classes are created by thresholding, the above class separation measures could be applied for information scores.

Those ordinary skilled in the art should recognize that other information measurement such as entropy and discriminate analysis measurements could be used as information scores and they are all within the scope of the current invention.

### II.2 Ranking

The ranking method 322 inputs the information scores 300 of the features from the initial feature list 102 and ranks them in ascending or descending orders. This results in the ranked feature list 304 output.

### II.3 Object Sorting

The object sorting method 326 inputs the profiling feature 306 index and its associated initial features 106 for all learning objects deriving from the learning image 100 and the object masks 104. It sorts the objects according to their profiling feature values in ascending or descending order. This results in the sorted object sequence as well as their object feature values.

### II.4 Object Montage Creation

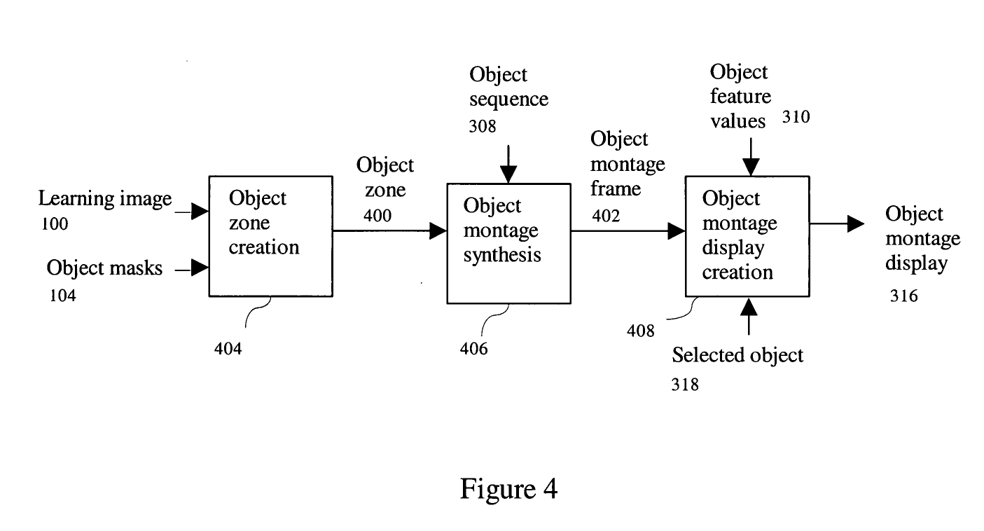

The processing flow for the object montage creation method is shown in FIG. 4. As shown in FIG. 4, an object zone creation step 404 inputs the leaning image 100 and the object masks 104 to generate an object zone 400 for each of the objects in the object masks 104. In one embodiment of the invention, the object zone 400 is a rectangular region of the learning image covering the mask of the object, object Region of Interest (ROI). In another embodiment of the invention, an expanded region of the object ROI is used as the object zone. The object masks 104 could be associated with the object zone so object mask overlay can be provided.

The object zone 400 for each of the objects are processed by an object montage synthesis step 406 that inputs the object sequence 308 to synthesize the object montage containing a plurality of object zones ordered by the object sequence 308 to form an object montage frame 402. An object montage frame 402 is a one-dimensional or two-dimensional frame of object zones where the zones are ordered according to the object sequence 308.

The object mintage frame 402 is processed by an object montage display creation step 408 that associates the object feature values 310 to the object montage frame 402. The object feature values 310 can be hidden or shown by user control through the user interface 324. Also, object zone(s) 400 are highlighted for the selected object(s) 318. The highlight includes either a special indication such as frame drawing or object mask overlay. The object montage frame 402 containing feature value association and selected object highlighting forms the object montage display 316 output.

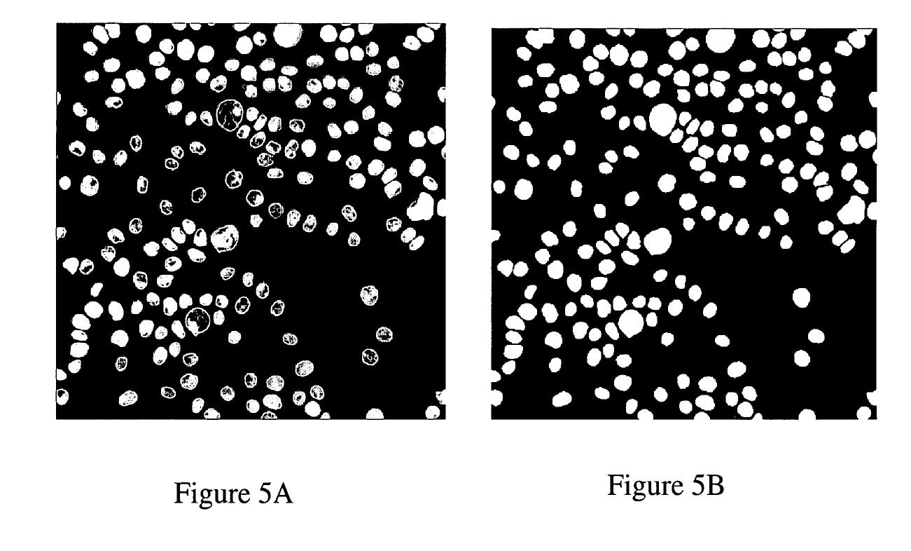

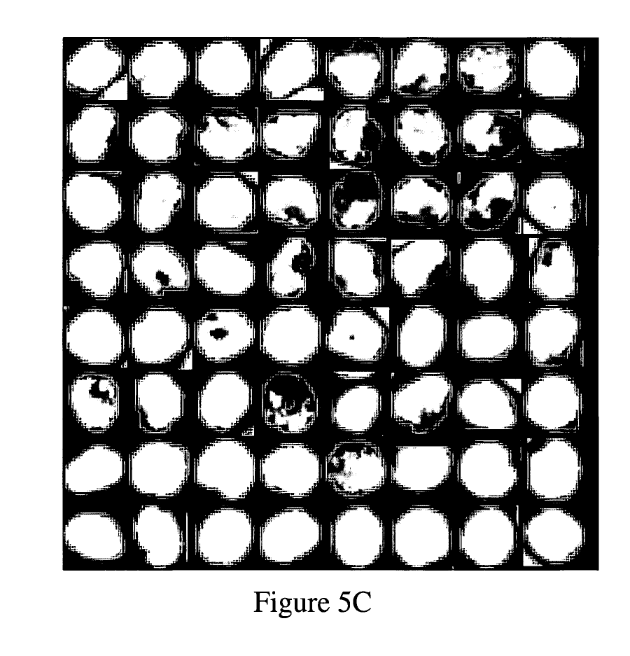

FIG. 5A shows an example image of cell nuclei. Its object masks are shown in FIG. 5B. An object montage of a subset of the objects in FIG. 5B is shown in FIG. 5C.

### II.5 Histogram Creation

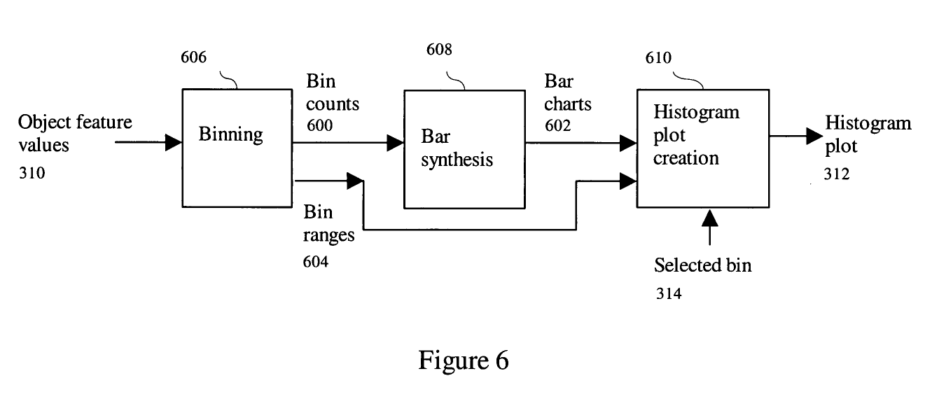

The processing flow for the histogram method is shown in FIG. 6. As shown in FIG. 6, a binning step 606 inputs the object feature values 310 to generate the bin ranges 604 and bin counts 600. To determine the bin ranges 604, the number of bins is determined first. The number of bins could be from a pre-set value, from user input, or derived automatically from the object feature value distribution and the object counts. After the number of bins is determined the bin ranges 604 can be defined by either equal quantization or normalized quantization methods that are common in the art. The bin count 600 for a bin can be determined by simply counting the number of objects having feature values fall within the bin range of the corresponding bin. The bin counts 600 are processed by a bar synthesis step 608 to generate bar charts 602 where the number of bars are the same as the number of bins and the heights of the bar charts 602 are scaled according to the maximum bin count 600s. The bar charts 602 and the bin ranges 604 are processed by the histogram plot creation step 610 to generate histogram plot 312 that associates the values in bin ranges and the counts in the histogram plot 312. When the selected bin 314 is inputted, the selected bin(s) 314 in the histogram plot 312 is highlighted.

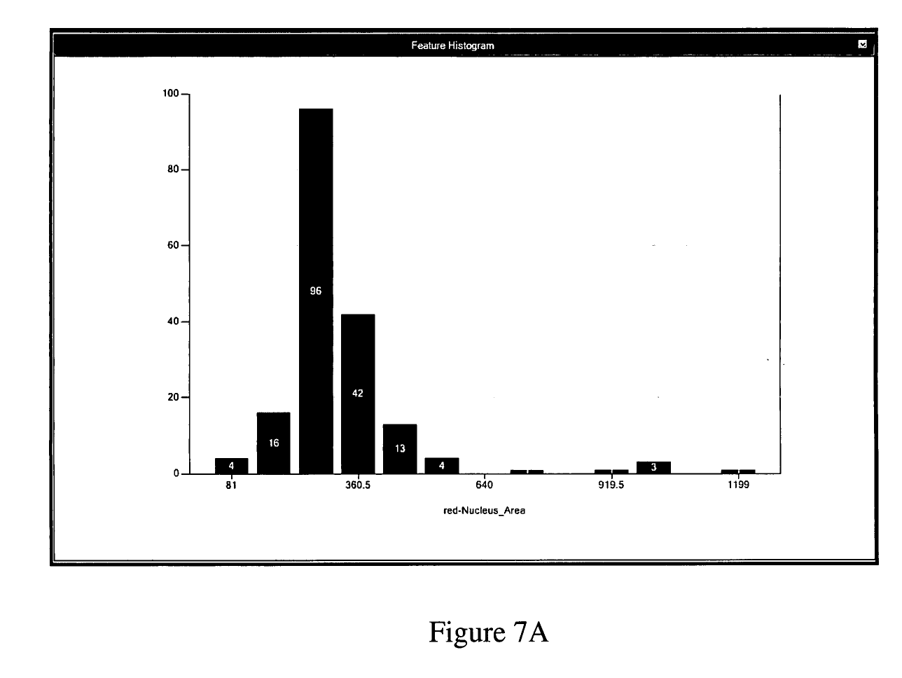

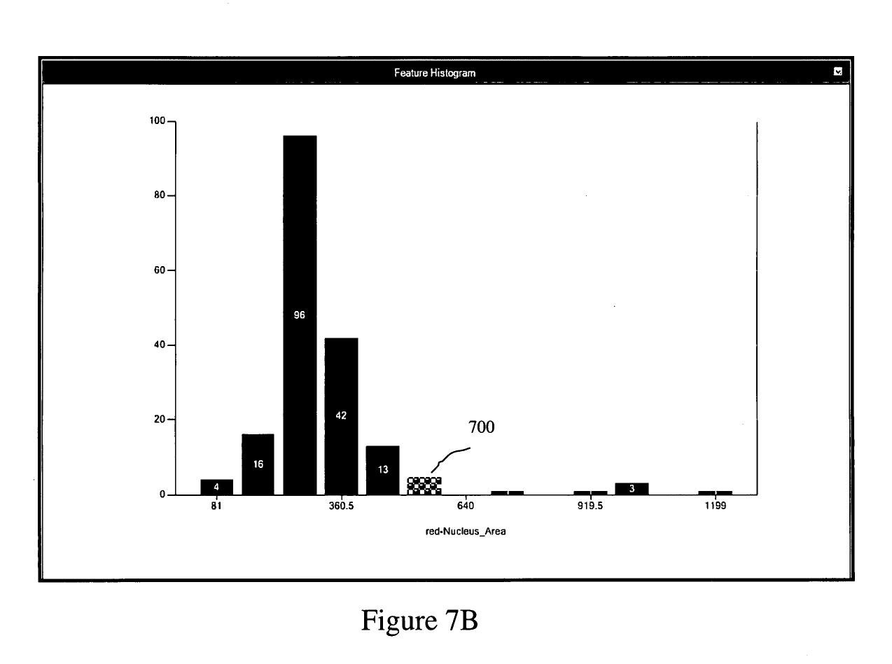

FIG. 7A shows the histogram plot of a feature for the objects in FIG. 5B. FIG. 7B shows a bin 700 is selected and highlighted with a different pattern.

### II.6 User Interface

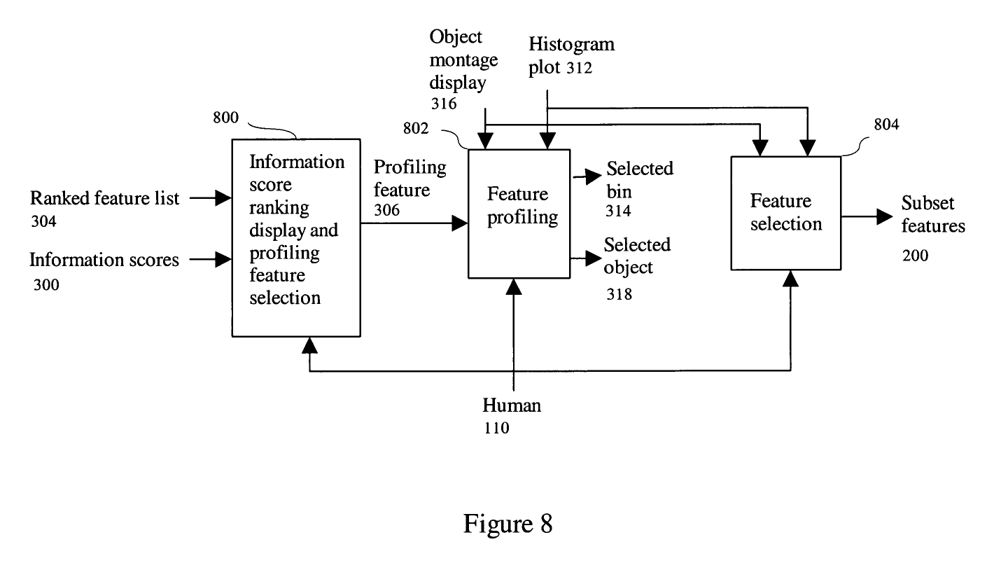

The user interface step 324 of the invention displays the ranked feature list 304 and their information scores 300 and allows human 110 to select profiling feature 306 for object montage creation 330. The processing flow for the user interface is shown in FIG. 8. As shown in FIG. 8, the ranked feature list 304 and their information scores 300 are processed by an information score ranking display and profiling feature selection step 800. The step shown the information scores of the ranked features to the human 110 for the selection of profiling feature 306 output. The human selected profiling feature 306 is processed by a feature profiling step 802 that shows the object montage display 316 and optionally shows the histogram plot 312 for the feature via a Graphical user interface. The human 110 could select histogram bins and/or select object for highlighting having selected bin 314 and selected object 318 outputs to the object montage creation 330 and the histogram creation 328 steps. The showing of object montage display 316 along with the histogram plot 312 allow human 110 to perform feature selection 804 yielding a subset of salient features after reviewing and visual evaluation from the profiling display. Those ordinary skilled in the art should recognize that the graphical user interface could include standard graphical tools such as zoom, overlay, window resizing, pseudo coloring, etc. The user interface allows visual evaluation and selection of for salient measurements. Human 110 do not have to know the mathematics behind measurement calculation.

### III. Contrast Boosting Feature Optimization

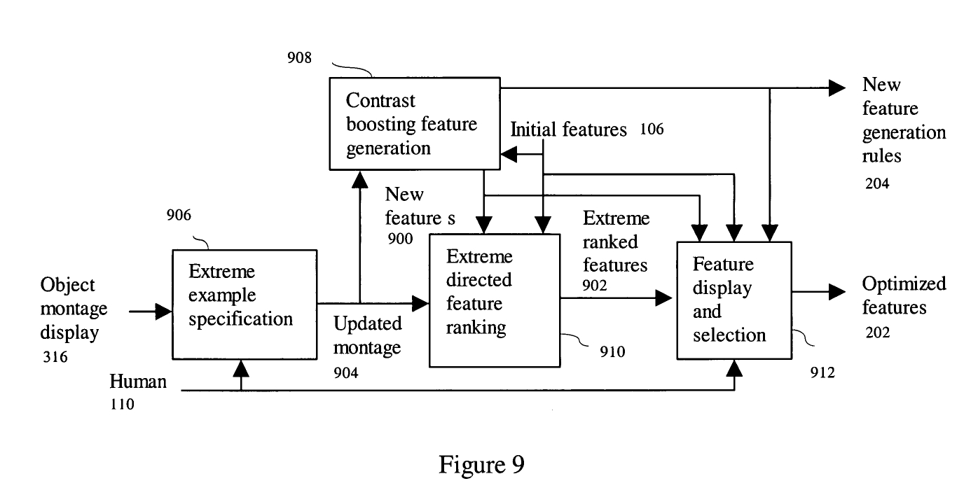

The contrast boosting method 208 of the invention allows user re-arrange objects on montage to specify extreme examples. This enables the utilization of application knowledge to guide feature selection. Initial features ranked by contrast between the user specified extreme examples are used for application specific feature selection. New features are generated automatically to boost the contrast between the user specified extreme examples for application specific feature optimization. The processing flow for the contrast boosting feature optimization method is shown in FIG. 9. As shown in FIG. 9, the human 110 performs extreme example specification 906 by re-arranging the object montage display 316. This results in the updated montage 904 output. The updated montage 904 including the extreme examples are used for contrast boosting feature generation 908 using the initial features 106. This outputs new features 900 and new feature generation rules 204. The new features 900 and the initial features 106 are processed by the extreme directed feature ranking step 910 based on the extreme example specified in the undated montage 904. This results in extreme ranked features 902 output. The extreme ranked features 902 are processed by the feature display and selection step 912 to generate optimized features 202 output.

### III.1 Extreme Example Specification

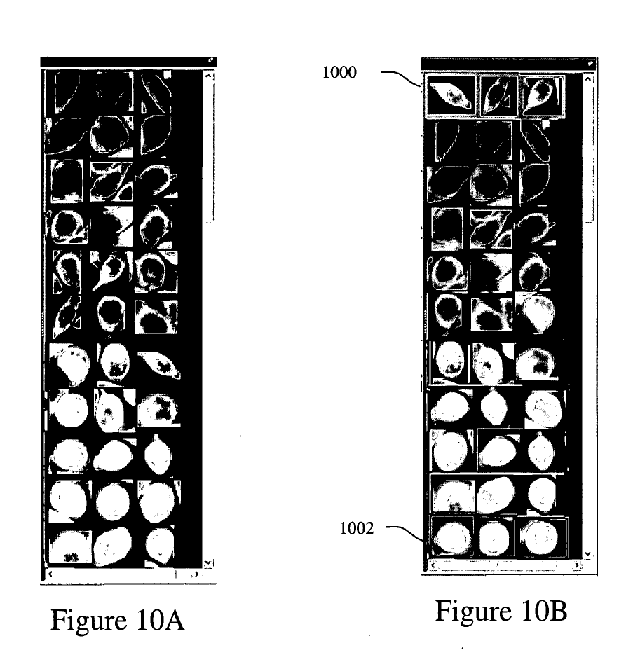

This invention allows human 110 to specify extreme examples by visual examination of montage object zones and utilizing application knowledge to guide the re-arrangement of object zones. The extreme example specification 906 is performed by re-arranging the objects in an object montage display 316. In this way, human 110 can guide the new feature generation and selection but do not have to know the mathematics behind computer feature calculation. Human 110 is good at identifying extreme examples of distinctive characteristics yet human 110 is not good at discriminating between borderline cases. Therefore, the extreme example specification 906 requires only human to move obvious extreme objects to the top and bottom of the object montage display 316. Other objects do not have to be moved. In the extreme examples that are moved by human 110, human could sort them according to the human perceived strength of the extreme feature characteristics. The updated object montage display 316 after extreme example specification forms the updated montage 904 output. The updated montage output specifies three populations: extreme 1 objects, extreme 2 objects, and other unspecified objects. FIG. 10A shows an example object montage display. FIG. 10B shows its updated montage where the extreme objects are highlighted by framing. The extreme 1 objects 1000 are located on the top and the extreme 2 objects 1002 are located at the top of the display.

### II.2 Contrast Boosting Feature Generation

The contrast boosting feature generation method automatically generates new features by combining a plurality of initial features to boost the contrast between the extreme examples.

In a particularly preferred, yet not limiting embodiment, the present invention uses two initial feature combination for new feature generation, three types of new features are generated:
Weighting: Feature_1+boosting_factor*Feature_2
Normalization: Feature_1/Feature_2
Correlation: Feature_1*Feature_2

The ordinary skilled in the art should recognize that the combination could be performed iteratively using already combined features as the source for new combination. This will generate new features involving more than two initial features without changing the method. To assure that there is no division by zero problem, in one embodiment of the invention, the normalization combination is implemented in the following form:

Feature_1/(Feature_2+α)

Where α is a small non-zero value.

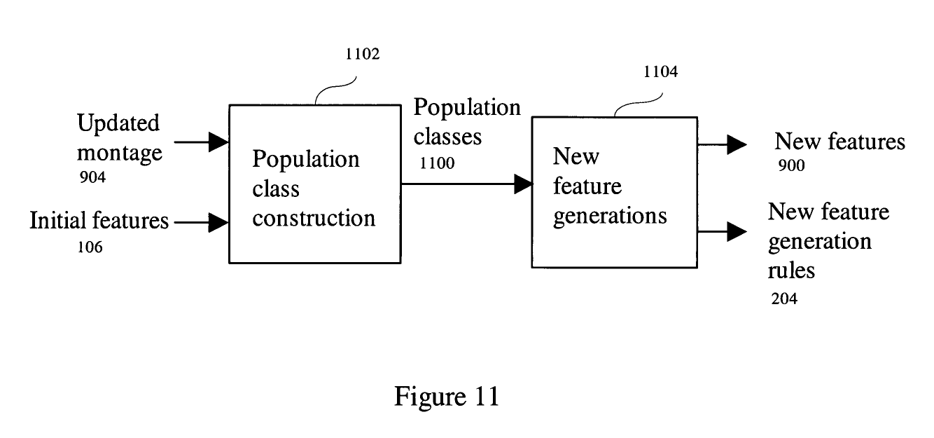

The processing flow for the contrast boosting feature generation is shown in FIG. 11. As shown in FIG. 11, the updated montage 904 and the initial features 106 are processed by a population class construction step 1102 to generate population classes 1100. The population classes 1100 are used for new feature generations 1104 to generate new features 900 and output new feature generation rules 204.

### A. Population Class Construction

The updated montage 904 specifies three populations: extreme 1 objects, extreme 2 objects, and other unspecified objects. The population class construction 1102 generates three classes and associate them with the initial features. In the following, we call extreme 1 objects as class 0, extreme 2 objects as class 1, and the other objects as class 2.

### B. New Feature Generation

For the new features with fixed combination rules such as:
Normalization: Feature_1/Feature_2
Correlation: Feature_1*Feature_2
   the new feature generation is a straightforward combination of initial features. However, some combination rules require the determination of parameter values. For example, the weighting combination method:
Weighting: Feature_1+boosting_factor*Feature_2

Requires the determination of the boosting_factor. To determine the parameters, goodness metrics are defined.

### Goodness Metric

The goodness metric for contrast boosting consists of two different metrics. The first metric (D) measures the discrimination between class 0 and class 1. The second metric (V) measures the distribution of the class 2 with respect to the distribution of the class 0 and class 1. The metric V estimates the difference between distribution of the class 2 and the distribution of the weighted mean of the class 0 objects and class 1 objects. In one embodiment of the invention, the two metrics include discrimination between class 0 and class 1 (D) and class 2 (V) difference as follows:

$$D = \frac{{( {m}_{0} - {m}_{1} )}^{2}}{{}_{}^{w}{σ}{}_{0}^{2} + {}_{}^{( 1 - w )}{σ}{}_{1}^{2}}$$

$$V = \frac{{[ ( {m}_{2} - {vm}_{0} - ( 1 - v ) {m}_{1} ) ]}^{2}}{{σ}_{2}^{2} + {v}^{2} {σ}_{0}^{2} + {( 1 - v )}^{2} {σ}_{1}^{2}}$$

where m₀, m₁, and m₂ are mean of the class 0, class 1, and class 2, and σ₀, and σ₁, and σ₂ are the standard deviation of the class 0, class 1, and class 2, respectively. The parameter w is a weighting factor for the population of the classes and the parameter v is a weighting value for the importance of the class 0 and class 1. In one embodiment of the invention, the value of the weight w is

$$w = \frac{number of objects of class 0}{total number of objects}$$

In another embodiment of the invention, we set w=1 without considering the number of objects. In a preferred embodiment of the invention, the value of v is set to 0.5. This is the center of the distribution of the class 0 and class 1. Those ordinary skilled in the art should recognize that other values of w and v can be used and they are within the scope of this invention.

In a particularly preferred, yet not limiting embodiment, the goodness metric of the contrast boosting is defined so that it is higher if D is higher and V is lower. Three types of the rules satisfying the goodness metric properties are provided as non-limiting embodiment of the invention.

$$J 1 = D - γ V$$

$$J 2 = \frac{D}{1 + γ V}$$

$$J 3 = D {e}^{- γ V}$$

In one embodiment of the invention, the new feature generation rules are simply the selected initial features and pre-defined feature combination rules with its optimal boosting_factor values.

### Boosting Factor Determination

The boosting factor determination method determines the boosting factor for the best linear combination of two features: Feature_1+boosting_factor*Feature_2.

Let two features be f and g, the linear combined features can be written as

h=f+αg

### Where α is the boostinmg_factor.

### 1. Parametric Method

From the above method, the mean, variance and covariance are

m₀=m_{0f}+αm_{0g}

m₁=m_{1f}αm_{1g}

m₂=m₂+αm_{2g}

σ₀²=σ_{0f}²+2ασ_{0fg}+α²σ_{0g}²

σ₁²=σ_{1f}²+2ασ_{1fg}+α²σ_{0g}²

σ₁¹=σ_{2f}²+2ασ_{2fg}+α²σ_{2g}²

Combining the above methods, the metric D can be rewritten as follows:

$$D = \frac{{( {p}_{1} + α {p}_{2} )}^{2}}{{q}_{1}^{+ 2 α} {q}_{2} + {α}^{2} {q}_{3}}$$

and its derivative as follows:

$${D}^{′} = \frac{d D}{d α} = \frac{2 ( {p}_{1} + α {p}_{2} ) [ ( {p}_{2} {q}_{1} - {p}_{1} {q}_{2} ) + α ( {p}_{2} {q}_{2} - {p}_{1} {q}_{3} ) ]}{{( {q}_{1} + 2 α {q}_{2} + {α}^{2} {q}_{3} )}^{2}}$$

where

p₁=m_{0f}+m_{1f}

p₂=m_{0g}+m_{1g}

q₁=wσ_{0f}²+(1−w)σ_{1f}²

q₂=wσ_{0fg}+(1−w)σ_{1fg}

q₃=wσ_{0g}²+(1−w)σ_{1g}²

and metric v can be rewritten as follows:

$$V = \frac{{( {r}_{1} + α {r}_{2} )}^{2}}{{s}_{1} + 2 {α}_{{S}_{2}} + {α}^{2} {s}_{3}}$$

and its derivative as follows:

$${V}^{′} = \frac{d V}{d α} = \frac{2 ( {r}_{1} + {}_{}^{α}{r}{}_{2}^{} ) [ ( {r}_{2} {s}_{1} - {r}_{1} {s}_{2} ) + α ( {r}_{2} {s}_{2} - {r}_{1} {s}_{3} ) ]}{{( {s}_{1} 2 {α}_{{s}_{2}} + {α}^{2} {s}_{3} )}^{2}}$$

where

r₁=m_{2f}^{-v}m_{0f}−(1−v)m_{1f}

r₂=m_{2g}^{-v}m_{0g}−(1−v)m_{1g}

s₁=σ_{2f}²+v²σ_{0f}²+(1−v)²σ_{1f}²

s₂=σ_{2fg}+v²σ_{0fg}+(1−v)²σ_{1fg}

₃=σ_{2g}²+v²σ_{0g}²+(1−v)²σ_{1g}²

### To maximize the goodness functions, find the proper α so that

$$\frac{d J}{d α} = 0.$$

### For each cases, the best α value is the solution of the

$$\frac{d J 1}{d α} = {D}^{′} - γ {V}^{′} = 0$$

$$\frac{d J 2}{d α} = \frac{{D}^{′} ( 1 + γ V ) - γ {DV}^{′}}{{( 1 - γ D )}^{2}} = 0$$

$$\frac{d J 3}{d α} = ( {D}^{′} - γ {DV}^{′} ) {e}^{- γ V} = 0$$

### 2. Non-Parametric Method

The parametric method of finding a is under the Gaussian assumption. In many practical applications, however, the Gaussian assumption does not apply. In one embodiment of the invention, a non-parametric method using the area ROC (receiver operation curve) is applied.

In Gaussian distribution, the smaller area ROC (AR) is

AR=erfc(D)

where

$$\text{erf} c ( x ) = \frac{1}{\sqrt{2 π}} {\int }_{x}^{∞} exp ( - {t}^{2} / 2 ) d t$$

From the above relationship, we could defined:

D=erf⁻¹(AR)

Therefore, the procedure to find the goodness metric D is
a Find the smallest area of ROC between the distribution of class 0 and class 1: ARD
b Calculate D=erf⁻¹(ARD)
   Finding the second goodness metric v is equivalent to finding the discrimination between distribution of class 2 and the weighted average of the distribution of the class 0 and class 1. Therefore, the procedure to get the second metric is as follows:
a Take data from class 0: f₀
b Take the data from class 1: f₁
c Weighted average: f₀₁=v f₀+(1−v)f₁
d Fond the smallest area of ROC between the distribution of class 2 and combined class 0 and 1: ARV
e Calculate V=erf⁻¹(ARV)

The best α is determined by maximizing the values in the above steps c, d, and e. In one embodiment of the invention, the operation of the erf⁻¹(x) is used in table or inverse function of the sigmoid functions.

### 3. Ranked Method

In the case that the ranking among the extreme examples is specified, one embodiment of the invention generates new features considering the ranks. The goodness metric include the integration of two metrics as follows:

JR1=E(1+γV)

JR2=Eₑ^{γV}

where E is the error estimation part of the metric and V is the class 2 part of the metric. The better feature is the one with smaller JR value.

The error estimation metric E for this case is simply related to the error of the ranks. When rank between 1 to LL and HH to N from the N objects are given, in one embodiment of the invention, the metric is

$$D = {\sum }_{r = 1}^{LL} {W}_{r} \vert rankofFeature - r \vert + {\sum }_{r = HH}^{N} {W}_{r} \vert rankofFeature - r \vert$$

which uses only rank information. However, the rank misleads the contrast boosting result when feature values of the several ranks are similar. To overcome this problem, in another embodiment of the invention, the metric is

$$D = \frac{{\sum }_{r = 1}^{LL} {{w}_{r} ( {\hat{f}}_{r} - {f}_{r} )}^{2} + {\sum }_{r = HH}^{N} {{w}_{r} ( {\hat{f}}_{r} - {f}_{r} )}^{2}}{{\hat{f}}_{HQ} - {\hat{f}}_{LQ}}$$

where fᵣ is the feature value of the given rank r and \hat{f}ᵣ is the feature value of the sorted rank r. \hat{f}_{HQ} and \hat{f}_{LQ} are the feature values of top 25 and 75 percentile. The weight value wᵣ can be used for the emphasis the specific rank. For example, wᵣ=1 or

$${w}_{r} = \frac{{N}^{2}}{{N}^{2} + γ r ( N - r )}$$

$${w}_{r} = \frac{N}{N + γ \sqrt{r ( N - r )}} .$$

The rank of class 2 is meaningless, so the comparison of the ranking is not meaningful. Therefore, the metric of given class may be better. The procedure of this method is
1. Find the mean and deviation of the rank [1, LL]: m₁, σ₁²
2. Find the mean and deviation of the rank [HH, N]: m₀, σ₀²
3. Find the mean and deviation of the others m₂, σ₂²
4. Find the V values using the previously described formula.

The boosting factor can be determined by finding the best α to have minimum of the cost1/cost2 using the new feature f+αg .

### III.3 Extreme Directed Feature Ranking

The new features and the initial features are processed to generate goodness metric using the methods described above. The goodness metrics represent extreme directed measures. Therefore, the features are ranked according to the goodness metrics. This results in the extreme ranked features for displaying to human 110.

### III.4 Feature Display and Selection

The feature display and selection 912 allows human 110 to select the features based on the extreme ranked features 902. The object montage display 316 of the selected features is generated using the previously described method. The object montage display 316 is shown to human 110 along with the new feature generation rules 204 and the generating features. After object montage display 316 reviewing, the human 110 makes the selection among the initial features 106 and the new features 900 for optimal feature selection. This results in the optimized features 202. The optimized features 202 along with their new feature generation rules 204 are the feature recipe output 108 of the invention.

The invention has been described herein in considerable detail in order to comply with the Patent Statutes and to provide those skilled in the art with the information needed to apply the novel principles and to construct and use such specialized components as are required. However, it is to be understood that the inventions can be carried out by specifically different equipment and devices, and that various modifications, both as to the equipment details and operating procedures, can be accomplished without departing from the scope of the invention itself.

What is claimed is:

1. A computerized directed feature development method comprising the steps of:
a) Input initial feature list, learning image and object masks;
b) Perform feature measurements using the initial feature list, the learning image and the object masks having initial features output;
c) Perform interactive feature enhancement by human using the initial feature list, the learning image, the object masks, and the initial features having feature recipe output.

2. The computerized directed feature development method of claim 1 wherein the interactive feature enhancement method further comprises a visual profiling selection step to generate a subset features.

3. The computerized directed feature development method of claim 1 wherein the interactive feature enhancement method further comprises a contrast boosting step to generate optimized features and new feature generation rules outputs.

4. A visual profiling selection method for computerized directed feature development comprising the steps of:
a) Input initial feature list, initial features, learning image and object masks;
b) Perform information measurement using the initial features having information scores output;
c) Perform ranking of the initial feature list using the information scores having a ranked feature list output;
d) Perform human selection through a user interface using the ranked feature list having a profiling feature output.

5. The visual profiling selection method for computerized directed feature development of claim 4 further comprises an object sorting step using the initial features and the profiling feature having an object sequence and object feature values output.

6. The visual profiling selection method for computerized directed feature development of claim 5 further comprises an object montage creation step using the learning image, the object masks, the object sequence and the object feature values having an object montage display output.

7. The visual profiling selection method for computerized directed feature development of claim 6 further performs human selection through a user interface using the object montage display having subset features output.

8. The visual profiling selection method for computerized directed feature development of claim 6 wherein the object montage creation comprising the steps of:
a) Perform object zone creation using the learning image and the object masks having object zone output;
b) Perform object montage synthesis using the object zone and the object sequence having object montage frame output;
c) Perform object montage display creation using the object montage frame and the object feature values having object montage display output.

9. The visual profiling selection method for computerized directed feature development of claim 5 further comprises a histogram creation step using the object feature values having an histogram plot output.

10. The visual profiling selection for computerized directed feature development method of claim 9 further performs human selection through a user interface using the histogram plot having subset features output.

11. The visual profiling selection method for computerized directed feature development of claim 9 wherein the histogram creation comprising the steps of:
a) Perform binning using the object feature values having bin counts and bin ranges output;
b) Perform bar synthesis using the bin counts having bar charts output;
c) Perform histogram plot creation using the bar charts and the bar ranges having histogram plot output.

12. A contrast boosting feature optimization method for computerized directed feature development comprising the steps of:
a) Input object montage display and initial features;
b) Perform extreme example specification by human using the object montage display having updated montage output;
c) Perform extreme directed feature ranking using the updated montage and the initial features having extreme ranked features output.

13. The contrast boosting feature optimization method of claim 12 further performs feature display and selection by human using the extreme ranked features and initial features having optimized features output.

14. The contrast boosting feature optimization method of claim 12 wherein the extreme directed feature ranking ranks features according to their goodness metrics.

15. The contrast boosting feature optimization method of claim 14 wherein the goodness metrics consist of discrimination between class 0 and class 1 and class 2 difference.

16. The contrast boosting feature optimization method of claim 12 further performs contrast boosting feature generation using the updated montage and initial features having new features and new feature generation rules output.

17. The contrast boosting feature optimization method of claim 16 wherein the new features selected from a set consisting of weighting, normalization, and correlation.

18. The contrast boosting feature optimization method of claim 16 wherein the extreme directed feature ranking using updated montage, new features, and initial features having extreme ranked features output.

19. The contrast boosting feature optimization method of claim 18 further performs feature display and selection by human using the extreme ranked features, new features, new feature generation rules and initial features having optimized features output.

20. The contrast boosting feature generation method of claim 16 comprising the steps of:
a) Perform population class construction using the updated montage and the initial features having population classes output;
b) Perform new feature generation using the population classes having new features and new feature generation rules output.
